(19) United States
(12) Patent Application Publication
(10) Pub. No.: US 2023/0076548 A1
(43) Pub. Date: Mar. 9, 2023

(54) Method and Device for Processing Programming Data

(71) Applicant: Kunming University of Science and Technology, Kunming (CN)

(72) Inventors: Ying JIANG, Kunming (CN); Chao SONG, Kunming (CN)

(21) Appl. No.: 17/739,184

(22) Filed: May 9, 2022

(30) Foreign Application Priority Data
Aug. 18, 2021 (CN) 202110950404.7

(51) Int. Cl. G06F 8/75; G06F 8/30; G06F 8/10

(52) U.S. Cl. CPC G06F 8/75; G06F 8/30; G06F 8/10

(57) ABSTRACT

The present disclosure discloses a method and a device for processing programming data. The method includes: acquiring programming data of a target object; identifying a programming behavior of the target object according to the programming data; and determining programming contribution rates of the target object, an automatic code generation tool and a programming platform according to the programming behavior.

### CROSS-REFERENCE TO RELATED APPLICATION

The present disclosure claims the priority of Chinese Patent Application No. 202110950404.7, filed to the China National Intellectual Property Administration on Aug. 18, 2021 and entitled “Method and Device for Processing Programming Data”, which is incorporated herein its entirety by reference.

### TECHNICAL FIELD

The present disclosure relates to the technical field of programming, in particular to a method and a device for processing programming data.

### BACKGROUND

At present, corresponding studies on an automatic code generation technology, programmer portraits and the like have been launched. Regarding automatic code generation, Liu Fang at al. have put forward a pre-training language model based on multi-task learning codes generation, to be specific, pre-training is carried out with a mixed target function combining code understanding and code generation tasks, a pre-trained model is micro-adjusted in code generation, and then common prediction and code generation are carried out through the multi-task learning. Veselin Raychev et al. have proposed an automatic code generation method with a statistical language model, a historic record invoked by a method of extracting an application programming interface (referred to as API) from a large codebase is taken as a training statement, and a code fragment combination with a highest probability is predicted with the statistical language model to generate API codes. Xu J. Y et al. have put forward a code generation method based on real-time process algebra (referred to as RTPA), and MATLAB codes as programmers expect are generated by learning RTPA coding rules. Bruch Marcel et al. have proposed an automatic code generation tool integrated on an Eclipse programming platform, to be specific, a context of codes in a programmer's development process is acquired and represented as feature vectors, and Java codes are generated by the best matching neighbors (referred to as BMN) algorithm. Tung Thanh Nguyen et al. have provided a statistical semantic language model for source code (referred to as SLAMC) and an SLAMC-based code generation method, existing codes are analyzed and their corresponding semantic code sequences are generated, and Java or C# codes are generated through an N-Gram model. Gong Q et al. have proposed a method based on hierarchical generative convolutional neural networks (referred to as HGCNN), source codes and corresponding input and output data of a programmer are taken as training data sets, code statements are predicted by an HGCNN neural network model, and codes are generated in accordance with a prediction result in combination with a traditional program searching technology. Hu Xing et al. have proposed a Hybrid-DeepCom method, which uses a natural language processing (NLP) technology to learn in a large codebase, and generates code annotations from a function of learning. Nguyen A T et al. have proposed an API code generation method, and API codes are generated by prediction capability of duplicated code changes based on fine-grained code changes and statistical learning of a context of the made changes. Bhoopchand A et al. have proposed a neural language model with a sparse pointer network, and codes required by a programmer are generated by capturing long dependencies between codes.

As programmers have their respective styles, automatic code generation tools or technologies can make targeted code recommendation in accordance with characteristics of the programmers. Yang Jun-wen et al. have provided a recommendation method for Web information sources based on programmer behaviors analysis and mining, which can automatically record and capture code browsing, changing and other actions of a programmer in a programming platform, acquire basic information from browsed webpage information, determine a relationship between the programmer behaviors and the Web information sources through clustering and time-based relevance analysis, and automatically recommend relevant Web information sources when the programmer implements a development task. Xie Xin-qiang et al. have proposed a multi-feature fusion collaborative filtering recommendation method for the programmers, which is based on capability and behavior awareness, recommends proper tasks for the programmers by analyzing dynamic behavior features of the programmers, enhancing and optimizing an evaluation matrix using a matrix decomposition and fitting technology, and carrying out feature fusion on an enhanced evaluation matrix, developer ability features and a developer-task similarity matching degree. Liu Ye-hui et al. have proposed a participant recommendation method for a problem-solving process in an open source community, firstly, constructing a programmer portrait according to features of a participating problem of the programmer, then carrying out feature preference weight calculation on the programmer portrait with an entropy method, and recommending participants for a newly initiated problem-solving process in combination with a information retrieval and a comment network. Yang Wen-hua et al. have proposed a multi-dimensional programmer portrait model, which specifies all aspects of properties of software development related to the programmer, and constructs a programmer portrait using methods of text analysis, Web data analysis and code analysis technologies, so as to help the programmer make better decisions in a process of collaborative software development.

A majority of existing studies focus on how to automatically generate codes based on corresponding methods, models or tools, or how to recommend codes or related information to the programmers as they expect based on previous behaviors of the programmers, without comprehensively considering and analyzing influences of the programmer, the automatic code generation tool and the programming platform on programming efficiency and quality. If behaviors and functions of the programmer, the automatic code generation tool and the programming platform cannot be clearly distinguished in a programming process, it is difficult to reflect their respective contribution on programming efficiency and quality.

In view of the technical problem in related technologies that the behaviors and the functions of the programmer, the automatic code generation tools and the programming platform cannot be clearly distinguished in the programming process so as not to reflect their respective contribution on the programming efficiency and quality, no effective technical solution has been proposed yet.

### SUMMARY

The embodiment of the present disclosure provides a method and a device for processing programming data.

According to one aspect of the embodiment of the present disclosure, a method for processing programming data is provided, the method including: the programming data of a target object is acquired; a programming behavior of the target object is identified according to the programming data; and programming contribution rates of the target object, an automatic code generation tool and a programming platform are determined according to the programming behavior.

Optionally, the programming data of the target object is acquired, includes: key operations of the target object in a programming process with the automatic code generation tool are monitored to acquire the programming data of the target object, and the programming data include at least one of: codes entered by the target object, selected codes recommended by the automatic code generation tool, selected codes recommended by the programming platform, deleted codes entered by the target object, deleted codes recommended by the automatic code generation tool, and deleted codes recommended by the programming platform.

Optionally, the programming behavior of the target object is identified according to the programming data, includes: the programming behavior of the target object as a behavior of entering codes by the target object is determined according to codes that are entered by the target object and are not deleted in the programming data; the programming behavior of the target object is determined to be a behavior of successfully recommending codes by the automatic code generation tool according to codes that are recommended by the automatic code generation tool, selected by the target object, and are not deleted in the programming data; and the programming behavior of the target object is determined to be a behavior of successfully recommending codes by the programming platform according to codes that are recommended by the programming platform, selected by the target object, and are not deleted in the programming data.

Optionally, the programming contribution rates of the target object, the automatic code generation tool and the programming platform are determined according to the programming behavior, includes: a quantity of codes entered by the target object, a quantity of codes successfully recommended by the automatic code generation tool, and a quantity of codes successfully recommended by the programming platform are determined according to the programming behavior; a total quantity of codes is acquired according to the quantity of the codes entered by the target object, the quantity of the codes successfully recommended by the automatic code generation tool, and the quantity of the codes successfully recommended by the programming platform; and the programming contribution rates of the target object, the automatic code generation tool and the programming platform are acquired according to the quantity of the codes entered by the target object, the quantity of the codes successfully recommended by the automatic code generation tool, the quantity of the codes successfully recommended by the programming platform, and the total quantity of the codes.

Optionally, the programming behavior includes a behavior of entering codes by the target object, a behavior of successfully recommending codes by the automatic code generation tool and a behavior of successfully recommending codes by the programming platform; and the quantity of the codes entered by the target object, the quantity of the codes successfully recommended by the automatic code generation tool, and the quantity of the codes successfully recommended by the programming platform are determined according to the programming behavior, includes: the quantity of the codes entered by the target object is determined according to the behavior of entering codes by the target object; the quantity of the codes successfully recommended by the automatic code generation tool is determined according to the behavior of successfully recommending codes by the automatic code generation tool; and the quantity of the codes successfully recommended by the programming platform is determined according to the behavior of successfully recommending codes by the programming platform.

Optionally, the programming contribution rates of the target object, the automatic code generation tool and the programming platform are acquired according to the quantity of the codes entered by the target object, the quantity of the codes successfully recommended by the automatic code generation tool, the quantity of the codes successfully recommended by the programming platform, and the total quantity of the codes, includes: a programming contribution rate of the target object is acquired according to the quantity of the codes entered by the target object and the total quantity of the codes; a programming contribution rate of the automatic code generation tool is acquired according to the quantity of the codes successfully recommended by the automatic code generation tool and the total quantity of the codes; and a programming contribution rate of the programming platform is acquired according to the quantity of the codes successfully recommended by the programming platform and the total quantity of the codes.

According to another aspect of the embodiment of the present disclosure, an apparatus for processing programming data is further provided, the apparatus including: an acquiring module, configured for acquiring the programming data of a target object; an identifying module, configured for identifying a programming behavior of the target object according to the programming data; a determination module, configured for determining programming contribution rates of the target object, an automatic code generation tool and a programming platform according to the programming behavior.

Optionally, the acquiring module includes: a processing unit, configured for monitoring key operations of the target object in a programming process with the automatic code generation tool to acquire the programming data of the target object, and the programming data include at least one of: codes entered by the target object, selected codes recommended by the automatic code generation tool, selected codes recommended by the programming platform, deleted codes entered by the target object, deleted codes recommended by the automatic code generation tool, and deleted codes recommended by the programming platform.

According to another aspect of the embodiment of the present disclosure, a processor is further provided, and the processor is configured for running a program, and the program executes the method for processing the programming data when the program runs.

### BRIEF DESCRIPTION OF THE DRAWINGS

The drawings described herein are just for promoting a further understanding of the present disclosure and form a part of the present application. The illustrative embodiments of the present disclosure and their descriptions serve to explain the present disclosure and do not intend to limit thereto. In the drawings:

FIG. 1 is a flow diagram of a method for processing programming data according to an embodiment of the present disclosure;

FIG. 2 is a flow diagram of acquiring programming data according to an optional embodiment of the present disclosure;

FIG. 3 is a flow diagram of identifying a programming behavior according to an optional embodiment of the present disclosure;

FIG. 4 is a flow diagram of analyzing a programming contribution rate according to an optional embodiment of the present disclosure;

FIG. 5 is a schematic diagram of an apparatus for processing programming data according to an embodiment of the present disclosure.

### DETAILED DESCRIPTION OF THE EMBODIMENTS

For those skilled in the art to better understand the solution of the present disclosure, the technical solution in the embodiment of the present disclosure will be dearly and completely described below in combination with the accompanying drawings in the embodiments of the present disclosure. Obviously, the described embodiments are only part of, not all of the embodiments of the present disclosure. Based on the embodiments of the present disclosure, all other embodiments obtained by an ordinary skilled person in the art without paying any creative efforts should be regarded as falling into the protection scope of the present disclosure.

It should be noted that, the terms “first” and “second” in the description, claims and the appended drawings of the present disclosure are used to distinguish similar objects, instead of describing in a specific order or sequential order. It should be understood that, the data used in this way can be interchanged where appropriate, so that the embodiments of the present disclosure described can be implemented in an order except for those illustrated or described herein. In addition, the terms “include” and “have” and any variations thereof are intended to cover in a non-exclusive sense. For example, a process, method, system, product or apparatus containing a series of steps or units is not necessarily limited to those steps or units clearly listed, but may include those not dearly listed or other steps or units inherent in the process, method, product or apparatus.

### Embodiment 1

According to an embodiment of the present disclosure, an embodiment of a method for processing programming data is provided. It should be noted that, the steps shown in the flow diagram of the accompanying drawings can be performed in a computer system with a set of computer executable instructions, and although the logical sequence is shown in the flow diagram, in some cases, the steps shown or described can be performed in another different order.

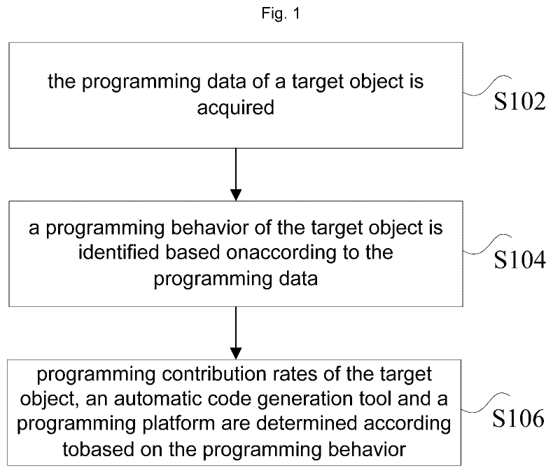

FIG. 1 is a flow diagram of the method for processing the programming data according to an embodiment of the present disclosure. As shown in FIG. 1, the method for processing the programming data includes the following steps:

Step S102: the programming data of a target object is acquired.

The target object above can refer to programming personnel, such as a programmer.

Optionally, the programming data of the target object is acquired, includes: key operations of the target object in a programming process with the automatic code generation tool are monitored to acquire the programming data of the target object, and the programming data include at least one of: codes entered by the target object, selected codes recommended by the automatic code generation tool, selected codes recommended by the programming platform, deleted codes entered by the target object, deleted codes recommended by the automatic code generation tool, and deleted codes recommended by the programming platform.

In a specific implementation process, codes that are entered by the target object and are not deleted can be calculated in accordance with the codes entered by the target object and the deleted codes entered by the target object; codes that are selected by the target object, recommended by the automatic code generation tool and are not deleted can be calculated in accordance with the selected codes recommended by the automatic code generation tool and the deleted codes recommended by the automatic code generation tool; and codes that are selected by the target object, recommended by the programming platform and are not deleted can be calculated in accordance with the selected codes recommended by the programming platform and the deleted codes recommended by the programming platform.

Step S104, a programming behavior of the target object is identified according to the programming data.

Optionally, the programming behavior of the target object is identified according to the programming data, includes: the programming behavior of the target object as a behavior of entering codes by the target object is determined according to codes that are entered by the target object and are not deleted in the programming data; the programming behavior of the target object is determined to be a behavior of successfully recommending codes by the automatic code generation tool according to codes that are recommended by the automatic code generation tool, selected by the target object, and are not deleted in the programming data; and the programming behavior of the target object is determined to be a behavior of successfully recommending codes by the programming platform according to codes that are recommended by the programming platform, selected by the target object, and are not deleted in the programming data.

It should be noted that, the programming behavior of the target object refers to an operation behavior of the target object in entering or selecting relevant codes in a programming process.

Step S106, programming contribution rates of the target object, an automatic code generation tool and a programming platform are determined according to the programming behavior.

Optionally, the programming contribution rates of the target object, the automatic code generation tool and the programming platform are determined according to the programming behavior, includes: a quantity of codes entered by the target object, a quantity of codes successfully recommended by the automatic code generation tool, and a quantity of codes successfully recommended by the programming platform are determined according to the programming behavior; a total quantity of codes is acquired according to the quantity of the codes entered by the target object, the quantity of the codes successfully recommended by the automatic code generation tool, and the quantity of the codes successfully recommended by the programming platform; and the programming contribution rates of the target object, the automatic code generation tool and the programming platform are acquired according to the quantity of the codes entered by the target object, the quantity of the codes successfully recommended by the automatic code generation tool, the quantity of the codes successfully recommended by the programming platform, and the total quantity of the codes.

Optionally, the programming behavior includes a behavior of entering codes by the target object, a behavior of successfully recommending codes by the automatic code generation tool and a behavior of successfully recommending codes by the programming platform, and the quantity of the codes entered by the target object, the quantity of the codes successfully recommended by the automatic code generation tool, and the quantity of the codes successfully recommended by the programming platform are determined according to the programming behavior, includes: the quantity of the codes entered by the target object is determined according to the behavior of entering codes by the target object; the quantity of the codes successfully recommended by the automatic code generation tool is determined according to the behavior of successfully recommending codes by the automatic code generation tool; and the quantity of the codes successfully recommended by the programming platform is determined according to the behavior of successfully recommending codes by the programming platform.

By the above embodiment, different programming behaviors are used to calculate quantities of codes corresponding to the different programming behaviors.

Optionally, the programming contribution rates of the target object, the automatic code generation tool and the programming platform are acquired according to the quantity of the codes entered by the target object, the quantity of the codes successfully recommended by the automatic code generation tool, the quantity of the codes successfully recommended by the programming platform, and the total quantity of the codes, includes: a programming contribution rate of the target object is acquired according to the quantity of the codes entered by the target object and the total quantity of the codes; a programming contribution rate of the automatic code generation tool is acquired according to the quantity of the codes successfully recommended by the automatic code generation tool and the total quantity of the codes; and a programming contribution rate of the programming platform is acquired according to the quantity of the codes successfully recommended by the programming platform and the total quantity of the codes.

By means of the above embodiment, programming contribution rates of different roles are respectively calculated in accordance with the quantity of the codes entered by the target object, the quantity of the codes successfully recommended by the automatic code generation tool, the quantity of the codes successfully recommended by the programming platform, and the total quantity of the codes, e.g., the programming contribution rate of the target object, the programming contribution rate of the automatic code generation tool and the programming contribution rate of the programming platform.

By the above steps, the programming data of the target object can be acquired; the programming behavior of the target object is identified according to the programming data; and the programming contribution rates of the target object, the automatic code generation tool and the programming platform are determined according to the programming behavior. Through acquiring the programming data in the programming process and analyzing relevant behaviors, behaviors and functions of different roles in the programming process can be distinguished and contributions of the different roles on programs are determined, thereby achieving a technical effect of rapidly and accurately grasping the contributions of a programmer, an automatic code generation tool and a programming platform on a program, thus resolving the technical problem in the related technologies that behaviors and functions of the programmer, the automatic code generation tool and the programming platform cannot be clearly distinguished in the programming process so as not to reflect their respective contribution on programming efficiency and quality.

An optional embodiment of the present disclosure will be further explained in detail below.

In an optional embodiment, the method for processing the programming data specifically includes the following implementation steps:

Step1, programming data is acquired: behavior data of a programmer is acquired by monitoring key operations of the programmer in a programming process with an automatic code generation tool; the behavior data of the programmer include: codes entered by the programmer, selected codes recommended by the automatic code generation tool, selected codes recommended by the programming platform, deleted codes entered by the programmer, deleted codes recommended by the automatic code generation tool, and deleted codes recommended by the programming platform.

Step2, a programming behavior is identified: for the data acquired in the Step1, identification is carried out on the codes (codes that are entered by the programmer and are not deleted) entered by the programmer, codes (codes that are selected by the programmer, recommended by the automatic code generation tool and are not deleted) successfully recommended by the automatic code generation tool to the programmer as he expects, and codes (codes that are selected by the programmer, recommended by the programming platform and are not deleted) successfully recommended by the programming platform to the programmer as he expects, and other complicated programming behaviors in the programming process; and

Step3, programming contribution rates are analyzed: for the complicated programming behaviors identified in the Step2, contribution rates of the programmer, the automatic code generation tool and the programming platform in the programming process are calculated by counting and calculating a quantity of codes entered by the programmer, a quantity of codes successfully recommended by the automatic code generation tool, and a quantity of codes successfully recommended by the programming platform.

Further, the above optional embodiment specially includes the following steps:

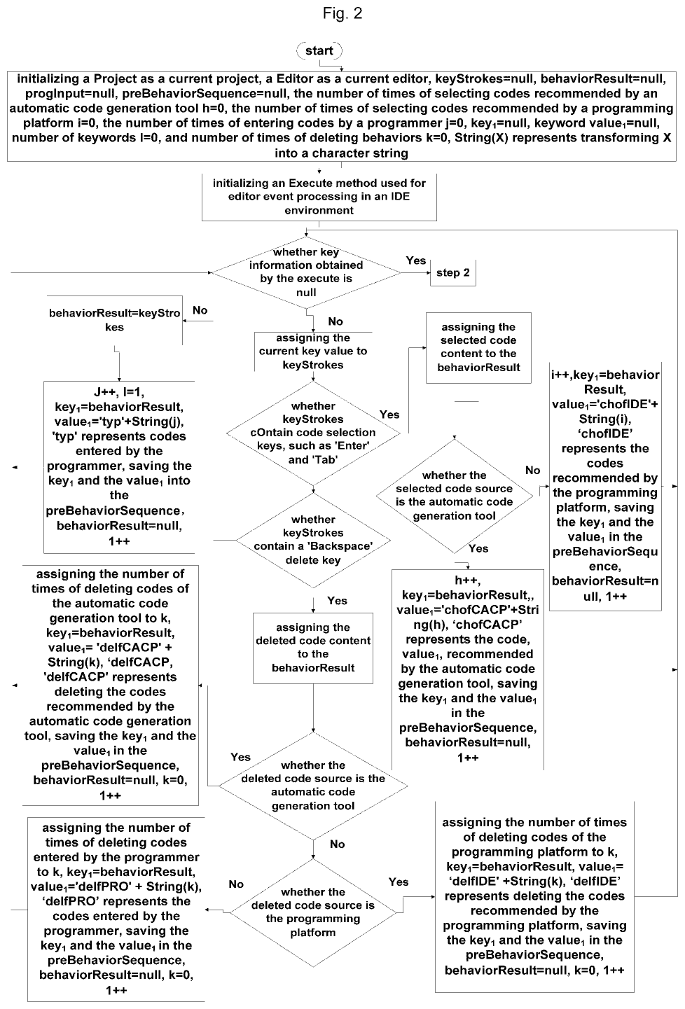

FIG. 2 is a flow diagram of acquiring programming data according to an optional embodiment of the present disclosure. As shown in FIG. 2, the programming data is acquired includes the following implementing steps:

Step1.1, a Project is initialized as a project ‘Demoi’ in development environment parameters in Table 1, a Editor is initialized as an editor ‘lntelliJ IDEA’ in the development environment parameters in the Table 1, a keyStrokes is initialized as null, a behaviorResult is initialized as null, a proglnput is initialized as null, a preBehaviorSequence as null, the number of times h of selecting codes recommended by an automatic code generation tool as 0, the number of times i of selecting codes recommended by a programming platform as 0, the number of times J of entering codes by a programmer as 0, a key₁ as null, a value₁ as null, the number I of keywords as 0, and the number of times k of deleting behaviors as 0, and Step1.2 is executed;

TABLE 1

| Property | Value |
|---|---|
| Project | Demo1 |
| Editor | IntelliJ IDEA |

Step1.2, an Execute method used for editor event processing is initialized in an IDE environment and Step1.3 is executed;

Step1.3, whether key information obtained by the Execute is null is judged, a key “def” is entered in the editor by the programmer, a current key value obtained by the Execute is ‘def’, and the Step1.4 is executed;

Step1.4, the current key value ‘def’ is assigned to the keyStrokes, that is, keyStrokes=‘def’, and Step1.5 is executed;

Step1.5, whether the keyStrokes contain code selection keys, such as ‘Enter’ key and ‘Tab’ key is judged, keyStrokes=‘def’, and Step1.10 is executed;

Step1.10, whether the keyStrokes contain a ‘Backspace’ delete key is judged, keyStrokes=‘def’, and Step1.17 is executed;

Step1.17, behaviorResult=keyStrokes, behaviorResult=‘def’, Step1.18 is executed;

Step118, j++, j=1, I=0, key₀=behaviorResult, key₀=‘def’, value₀=‘typ’+String(1), value₀=‘typ1’, ‘typ’ represents selected codes entered by the programmer, the key₀ and the value₀ are saved into the preBehaviorSequence, preBehaviorSequence={‘def’=‘typ1’}, behaviorResult=null, I++, I=1, Step1.3 is executed;

Step1.3, whether the key information obtained by the Execute is null is judged, a key ‘fac(n):’ is entered in the editor by the programmer, a current key value obtained by the Execute is ‘fac(n):’, and Step1.4 is executed;

Step1.4, the current key value ‘fac(n):’ is assigned to the keyStrokes, keyStrokes=‘fac(n):’, and Step1.5 is executed;

Step1.5, whether the keyStrokes contain code selection keys, such as ‘Enter’ and ‘Tab’, keyStrokes=‘fac(n):’ is judged, and Step1.10 is executed;

Step1.10, whether the keyStrokes contain the ‘Backspace’ delete key, keyStrokes=‘fac(n):’ is judged, and Step1.17 is executed;

Step1.17, behaviorResult=keyStrokes, behaviorResult=‘fac(n):’, Step1.18 is executed;

Step1.18, j++, j=2, I=1, key₁=behaviorResult, key₁=‘fac(n):’, value₁=‘typ’+String(2), value₁=‘typ2’, ‘typ’ represents selected codes entered by the programmer, the key₁ and the value₁ are saved into the preBehaviorSequence, preBehaviorSequence={‘def’=‘typ1’, ‘fac(n):’=‘typ2’}, behaviorResult=null, I++, I=2, Step1.3 is executed;

Step1.3, whether the key information obtained by the Execute is null is judged, a key ‘Enter’ is entered in the editor by the programmer, a current key value obtained by the Execute is ‘Enter’, and

Step1.4 is executed;

Step1.4, the current key value ‘Enter’ is assigned to the keyStrokes, keyStrokes=‘Enter’, and

Step1.5 is executed;

Step1.5, whether the keyStrokes contain code selection keys, such as ‘Enter’ and ‘Tab’ is judged, keyStrokes=‘Enter’, and Step1.6 is executed;

Step1.6, the selected code content is assigned to the behaviorResult, behaviorResult=‘import’, and Step1.7 is executed;

Step1.7, whether a code source which is selected is an automatic code generation tool is judged, and if the code source is the automatic code generation tool, Step1.8 is executed;

Step1.8, h++, h=1, I=2, key₂=‘import’, value₂=‘chofCACP’+String(1), value₂=‘chofCACP1’, ‘chofCACP’ represents selected codes recommended by the automatic code generation tool, the key₂ and the value₂ are saved in the preBehaviorSequence, preBehaviorSequence={‘def’=‘typ1’, ‘fac(n):’=‘typ2’, ‘import’=‘chofCACP1’}, behaviorResult=null, I++, I=3, Step1.3 is executed;

Step1.3, whether the key information obtained by the Execute is null is judged, a key ‘Backspace’ is entered in the editor by the programmer, a current key value obtained by the Execute is ‘Backspace’, and Step1.4 is executed;

Step1.4, the current key value ‘Backspace’ is assigned to the keyStrokes, keyStrokes=‘Backspace’ and Step1.5 is executed;

Step1.5, whether the keyStrokes contain code selection keys, such as ‘Enter’ and ‘Tab’ is judged, keyStrokes=‘Backspace’, and Step1.10 is executed;

Step1.10, whether the keyStrokes contain the ‘Backspace’ delete key is judged, keyStrokes=‘Backspace’, and Step1.11 is executed;

Step1.11, the deleted code content is assigned to the behaviorResult, behaviorResult=‘import’, and Step1.12 is executed;

Step1.12, whether a deleted code source is the automatic code generation tool is judged, and if the deleted code source is the automatic code generation tool, Step1.13 is executed;

Step1.13, the number of times of deleting codes from the automatic code generation tool is assigned to k, k=1, I=3, key₃=behaviorResult, key₃=‘import’, value₃=‘delfCACP’+String(1), value₃=‘deIfCACP1’, ‘delfCACP’ represents the codes recommended by the automatic code generation tool, a key₃ and a value₃ in the preBehaviorSequence are saved and preBehaviorSequence={def=‘typ1’, ‘fac(n):’=‘typ2’, ‘import’=‘chofCACP1’, ‘import’=‘delfCACP1’}, behaviorResult=null, k=0, I++, I=4, and Step1.3 is executed;

Step1.3, whether the key information obtained by the Execute is null is judged, a key ‘Enter’ is entered in the editor by the programmer, a current key value obtained by the Execute is ‘Enter’, and Step1.4 is executed;

Step1.4, the current key value ‘Enter’ is assigned to the keyStrokes, keyStrokes=‘Enter’, and Step1.5 is executed;

Step1.5, whether the keyStrokes contain code selection keys, such as ‘Enter’ and ‘Tab’ is judged, keyStrokes=‘Enter’, and Step1.6 is executed;

Step1.6, the selected code content is assigned to the behaviorResult, behaviorResult=‘if’, and Step1.7 is executed;

Step1.7, whether the selected code source is the automatic code generation tool is judged, and if the code source is the automatic code generation tool, Step1.8 is executed;

Step1.8, h++, h=2, I=4, key₄=behaviorResult, key₄=‘if’, value₄=‘chofCACP’+String(2), value₄=‘chofCACP2’. ‘chofCACP’ represents selected codes recommended by the automatic code generation tool, the key₄ and the value₄ are saved into the preBehaviorSequence, preBehaviorSequence={‘def’=‘typ1’, ‘fac(n):’=‘typ2’,‘import’=‘chofCACP1’, ‘import’=‘delfCACP1’, ‘if’=‘chofCACP2’}, behaviorResult=null, I++, I=5, Step1.3 is executed;

Step1.3, whether the key information obtained by the Execute is null is judged, a key ‘n==1:’ is entered in the editor by the programmer, a current key value obtained by the Execute is ‘n==1:’, and Step 1.4 is executed;

Step1.4, the current key value ‘n==1:’ is assigned to the keyStrokes, keyStrokes=‘n==1:’, and Step1.5 is executed;

Step1.5, whether the keyStrokes contain code selection keys, such as ‘Enter’ and ‘Tab’ is judged, keyStrokes=‘n==1:’, and Step1.10 is executed;

Step1.10, whether the keyStrokes contain the ‘Backspace’ delete key is judged, keyStrokes=‘n==1’, and Step1.17 is executed;

Step1.17, behaviorResult=keyStrokes, behaviorResult=‘n==1:’, Step1.18 is executed;

Step1.18, j++, j=3, I=5, key₅=behaviorResult, key₅=‘n==1:’, value₅=‘typ’+String(3), value₅=‘typ3’, ‘typ’ represents the codes entered by the programmer, the key₅ and the value₅ are saved in the preBehaviorSequence, preBehaviorSequence={‘def=‘typ1’,‘fac(n):’=‘type2’, ‘import’=‘chofCACP1’,‘import’=‘delfCACP1’, ‘if’=‘chofCACP2’,‘n==1:’=‘typ3’}, behaviorResult=null, I++, I=6, Step1.3 is executed;

Step1.3, whether the key information obtained by the Execute is null is judged, a key ‘Enter’ is entered in the editor by the programmer, a current key value obtained by the Execute is ‘Enter’, and Step1.4 is executed;

Step1.4, the current key value ‘Enter’ is assigned to the keyStrokes, keyStrokes=‘Enter’, and Step1.5 is executed;

Step1.5, whether the keyStrokes contain code selection keys, such as ‘Enter’ and ‘Tab’ is judged, keyStrokes=‘Enter’, and Step1.6 is executed;

Step1.6, the selected code content is assigned to the behaviorResult, behaviorResult=‘reversed’, Step1.7 is executed;

Step1.7, whether the code source which is selected is the automatic code generation tool is judged, and if the code source is a programming platform. Step1.9 is executed;

Step1.9, i++, i=1, I=6, key₆=behaviorResult, key₆=‘reversed’, valuee=‘chofIDE’+String(1), value6=‘chofIDE1’, ‘chofIDE’ represents selected codes recommended by the programming platform, the key₆ and the value₆ are saved into the preBehaviorSequence, preBehaviorSequence={‘def’=‘typ1’,‘fac(n):’=‘type2’, ‘import’=‘chofCACP1’, ‘import’=‘delfCACP1’, ‘if’=‘chofCACP2’, ‘n==1:’=‘typ3’, ‘reversed’=‘chofIDE1’}, behaviorResult=null, I++, I=7, Step1.3 is executed;

Step1.3, whether the key information obtained by the Execute is null is judged, a key ‘Backspace’ is entered in the editor by the programmer, a current key value obtained by the Execute is ‘Backspace’, and Step1.4 is executed;

Step1.4, the current key value ‘Backspace’ is assigned to the keyStrokes, keyStrokes=‘Backspace’ and Step1.5 is executed;

Step1.5, whether the keyStrokes contain code selection keys, such as ‘Enter’ and ‘Tab’ is judged, keyStrokes=‘Backspace’, and Step1.10 is executed;

Step1.10, whether the keyStrokes contain the ‘Backspcae’ delete key is judged, keyStrokes=‘Backspace’, and Step1.11 is executed;

Step1.11, the deleted code content is assigned to the behaviorResult, behaviorResult=‘reversed’, Step1.12 is executed;

Step1.12, whether the deleted code source is the automatic code generation tool is judged, and if the deleted code source is the programming platform. Step1.14 is executed;

Step1.14, whether the deleted code source is the programming platform is judged, and if the deleted code source is the programming platform, Step1.15 is executed;

Step1.15, the corresponding number of times of deleted codes entered by the programmer is assigned to k, k=1, I=7, key?=behaviorResult, key₇=‘reserved’, value₇=‘detfIDE’+String(1), value₇=‘delfIDE1’, ‘delfIDE’ represents deleted codes recommended by the programming platform, the key? and the value₇ are saved in the preBehaviorSequence, preBehaviorSequence=preBehaviorSequence={‘def’=‘typ1’, ‘fac (n):’=‘type2’, ‘import’=‘chofCACP1’, ‘import’=‘delfCACP1’, ‘if’=‘chofCACP2’,‘n==1:’=‘typ3’, ‘reversed’=‘chofIDE1’, ‘reversed’=‘delfIDE1’}, behaviorResult=null, k=0, I++, I=8, step1.3 is executed;

Step1.3, whether the key information obtained by the Execute is null is judged, a key ‘Enter’ is entered in the editor by the programmer, a current key value obtained by the Execute is ‘Enter’, and Step1.4 is executed;

Step1.4, the current key value ‘Enter’ is assigned to the keyStrokes, keyStrokes=‘Enter’, and Step1.5 is executed;

Step1.5, whether the keyStrokes contain code selection keys, such as ‘Enter’ and ‘Tab’ is judged, keyStrokes=‘Enter’, and Step1.6 is executed;

Step1.6, the selected code content is assigned to the behaviorResult, behaviorResult=‘return’, Step1.7 is executed;

Step1.7, whether the code source which is selected is the automatic code generation tool is judged, and if the code source is the programming platform, Step1.9 is executed;

Step1.9, i++, i=2, I=8, key₈=behaviorResult, key₈=‘return’, value₈=‘chofIDE’+String(2), value₈=‘chofIDE2’,‘chofIDE’ represents selected codes recommended by the programming platform, the key₈ and the value₈ are saved into the preBehaviorSequence, preBehaviorSequence={‘def’=‘typ1’, ‘fac(n):’=‘type2’, ‘import’=‘chofCACP1’,‘import’=‘defCACP1’, ‘if’=‘chofCACP2’,‘n==1:’=‘typ3’, ‘reversed’=‘chofIDE1’,‘reversed’=‘delfIDE1’, ‘return’=‘chofIDE2’}, behaviorResult=null, I++, I=9, Step1.3 is executed;

Step1.3, whether the key information obtained by the Execute is null is judged, the key ‘2’ is entered in the editor by the programmer, the current key value obtained by the Execute being ‘2’, and Step1.4 is executed;

Step1.4, the current key value ‘2’ is assigned to the keyStrokes, keyStrokes=‘2’, and Step1.5 is executed;

Step1.5, whether the keyStrokes contain code selection keys, such as ‘Enter’ and ‘Tab’ is judged, keyStrokes=‘2’, and Step1.10 is executed;

Step1.10, whether the keyStrokes contain the ‘Backspcae’ delete key is judged, keyStrokes=‘2’, and Step1.17 is executed;

Step1.17, behaviorResult=keyStrokes, behaviorResult=‘2’, Step1.18 is executed;

Step1.18, j++, j=4, I=9, key₉=behaviorResult, key₉=‘2’, value₉=‘typ’+String(4), value₉=‘typ4’, ‘typ’ represents the codes entered by the programmer, the key₉ and the value, are saved into the preBehaviorSequence, preBehaviorSequence={‘def’=‘typ1’,‘fac(n):’=‘type2’, ‘import’=‘chofCACP1’,‘import’=‘delfCACP1’, ‘if’=‘chofCACP2’,‘n==1:’=‘typ3’, ‘reversed’=‘chofIDE1’, ‘reversed’=‘delfIDE1’, ‘return’=‘chofIDE2’,‘2’=‘typ4’}, behaviorResult=null, I++, 1=10, Step1.3 is executed;

Step1.3, whether the key information obtained by the Execute is null is judged, a key ‘Backspace’ is entered in the editor by the programmer, a current key value obtained by the Execute is ‘Backspace’, and Step1.4 is executed;

Step1.4, the current key value ‘Backspace’ is assigned to the keyStrokes, keyStrokes=‘Backspace’ and Step1.5 is executed;

Step1.5, whether keyStrokes contain code selection keys, such as ‘Enter’ and ‘Tab’ is judged, keyStrokes=‘Backspace’, and Step1.10 is executed;

Step1.10, whether keyStrokes contain the ‘Backspace’ delete key is judged, keyStrokes=‘Backspace’, and Step1.11 is executed;

Step1.11, the deleted code content is assigned to the behaviorResult, behaviorResult=‘2’, and Step1.12 is executed;

Step1.12, whether the deleted code source is the automatic code generation tool is judged, and if the deleted code source is the programmer, Step1.14 is executed;

Step1.14, whether the deleted code source is the programming platform is judged, and if the deleted code source is the programmer, Step1.16 is executed.

Step1.16, the corresponding number of times of deleting the codes entered by the programmer is assigned to k, k=4, I=10, key₁₀=behaviorResult, key₁₀=‘2’, value₁₀=‘delfPRO’+String(4), value₁₀=‘delfPRO4’, ‘delfPRO’ represents deleted codes entered by the programmer, the key₁₀ and the value₁₀ are saved in the preBehaviorSequence, preBehaviorSequence=preBehaviorSequence={‘def=‘type1’,‘fac(n):’=‘type2’, ‘import’=‘chofCACP1’,‘import’=‘delfCACP1’, ‘if’=‘chofCACP2’,‘n==1:’=‘typ3’, ‘reversed’=‘chofIDE1’, reversed’=‘delfIDE1’, ‘return’=‘chofIDE2’,‘2’=‘type4’, ‘2’=‘delfPRO4’}, behaviorResult=null, k=0, I++, 1=11, Step1.3 is executed;

Step1.3, whether the key information obtained by the Execute is null is judged, the key ‘1’ is entered in the editor by the programmer, a current key value obtained by the Execute is ‘1’, and Step1.4 is executed;

Step1.4, the current key value ‘1’ is assigned to keyStrokes, keyStrokes=‘1’, and Step1.5 is executed;

Step1.5, whether the keyStrokes contain code selection keys, such as ‘Enter’ and ‘Tab’ is judged, keyStrokes=‘1’, and Step1.10 is executed;

Step1.10, whether the keyStrokes contain the ‘Backspcae’ delete key is judged, keyStrokes=‘1’, and Step1.17 is executed;

Step1.17, behaviorResult=keyStrokes, behaviorResult=‘1’, Step1.18 is executed;

Step1.18, j++, j=5, I=11, key₁₁=behaviorResult, key₁₁=‘1’, value₁₁=‘typ’+String(5), value₁₁=‘typ5’, ‘typ’ represents the codes entered by the programmer, the key₁₁ and the value₁₁ are saved into the preBehaviorSequence, preBehaviorSequence={‘def’=‘typ1’,‘fac(n):’=‘type2’, ‘import’=‘chofCACP1’, ‘import’=‘delfCACP1’, ‘if’=‘chofCACP2’, ‘n==1:’=‘typ3’, ‘reversed’=‘chofIDE1’, ‘reversed’=‘delfIEDE1’, ‘return’=‘chofIDE2’,‘2’=‘typ4’, ‘2’=‘delfPRO4’,‘1’=‘type5’}, behaviorResult=null, I++,I=12, Step1.3 is executed;

Step1.3, whether the key information obtained by the Execute is null is judged, and if the current key value obtained by the Execute is null, executing Step 2. At this time, the preBehaviorSequence is shown in Table 2.

TABLE 2

| Serial No. | Data |
|---|---|
| 0 | key₀=‘def’, value₀=‘typ1’ |
| 1 | key₁=‘fac(n):’, value₁=‘typ2’ |
| 2 | key₂=‘import’, value₂=‘chofCACP1’ |
| 3 | key₃=‘import’, value₃=‘delfCACP1’ |
| 4 | key₄=‘if’, value₄=‘chofCACP2’ |
| 5 | key₅=‘n==1:’; value₅=‘typ3’ |
| 6 | key₆=‘reversed’, value₆=‘chofIDE1’ |
| 7 | key₇=‘reversed’, value₇=‘delfIDEI’ |
| 8 | key₈=‘return’, value₈=‘chofIDE2’ |
| 9 | key₉=‘2’, value₉=‘typ4’ |
| 10 | key₁₀=‘2’, value₁₀=‘ delfPRO4’ |
| 11 | key₁₁=‘1’, value₁₁=‘typ5’ |

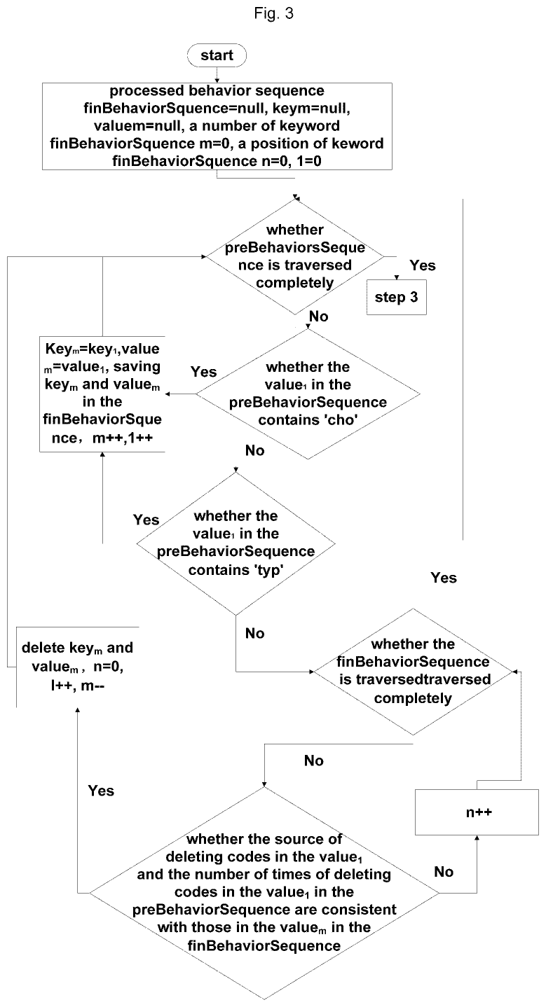

FIG. 3 is a process diagram of identifying a programming behavior according to an optional embodiment of the present disclosure. As shown in FIG. 3, the programming behavior is identified includes the following implementation steps:

Step2.1, as the processed behavior sequence finBehaviorSequence is null, a number m of keywords finBehaviorSequence is 0, a position n of the keyword finBehaviorSequence is 0, 1 is 0, a keyword keyₘ is null, and the value valueₘ is null, and a behavior judgment method is as shown in

TABLE 3

| Serial No. | Title | Behavior |
|---|---|---|
| 1 | ‘cho’ | Selecting |
| 2 | ‘typ’ | entering |

Step2.2, whether the preBehaviorsSequence is traversed completely is judged, 1=0, key₀=‘def’, value₀=‘typ1’, Step2.3 is executed;

Step2.3, whether value₀ in the preBehaviorSequence contains ‘Cho’ is judged, value₀=‘type1’, Step2.5 is executed;

Step2.5, whether the value₀ in the preBehaviorSequence contains ‘typ’ is judged, value₀=‘typ1’, Step2.4 is executed;

Step2.4, m=0, I=0, keyₘ=key₁, key₀=‘def’, valueₘ=value₁, value₀=‘typ1’, the key₀ and the value₀ are saved into the finBehaviorSequence, finBehaviorSequence={def=‘typ1’}, m++, I++, m=1, I=1, Step2.2 is executed;

Step2.2, whether the preBehaviorSequence is traversed completely is judged, I=1, key₁=‘fac(n):’, value₁=‘type2’, and Step2.3 is executed;

Step2.3, whether the value₁ in the preBehaviorSequence contains ‘Cho’ is judged, value₁=‘type2’, and Step2.5 is executed;

Step2.5, whether the value₁ in the preBehaviorSequence contains “typ” is judged, value₁=‘typ2’, Step2.4 is executed;

Step 2.4, m=1, I=1, keyₘ=key₁, key₁=‘fac(n):’, valueₘ=value₁, value₁=‘type2’, the key₁ and the value₁ are saved into the finBehaviorSequence, finBehaviorSequence={‘def’=‘typ1’,‘fac(n):’=‘type2’}, m++, m=2, I++, I=2, Step2.2 is executed;

Step2.2, whether the preBehaviorSequence is traversed completely is judged, key₂=‘import’, value₂=‘chofCACP1’, and Step2.3 is executed;

Step2.3, whether the value₂ in the preBehaviorSequence contains ‘Cho’ is judged, value₂=‘chofCACP1’, and Step2.4 is executed;

Step2.4, m=2, I=2, keyₘ=key₁, key₂=‘import’, valueₘ=value₁, value₂=‘chofCACP1’, the key₂ and the value₂ are saved into the finBehaviorSequence, finBehaviorSequence={‘def=‘typ1’, ‘fac(n):’=‘type2’, ‘import’=‘chofCACP1’}, m++, m=3, I++, I=3, Step2.2 is executed;

Step2.2, whether the preBehaviorSequence is traversed completely is judged, 1=3, key₃=‘import’, value₃=‘delfCACP1’, and Step2.3 is executed;

Step2.3, whether the value₃ in the preBehaviorSequence contains ‘Cho’ is judged, value₃=‘delfCACP1’, and Step2.5 is executed;

Step2.5, whether the value₃ in the preBehaviorSequence contains ‘typ’ is judged, value₃=‘delfCACP1’, Step2.6 is executed;

Step2.6, whether the finBehaviorSequence is traversed completely is judged, n=0, key₀=‘def’, value₀=‘typ1’, Step2.7 is executed;

Step2.7, whether the source of deleted codes and the number of times of deleting codes in the value₁ in the preBehaviorSequence are consistent with those in the valueₘ in the finBehaviorSequence are checked, and if not, Step2.9 is executed;

Step2.9, n++, n=1, Step2.6 is executed;

Step2.6, whether the finBehaviorSequence is traversed completely is judged, n=1, key₁=‘fac(n):’, value₁=‘type2’, Step2.7 is executed;

Step2.7, whether the source of the deleted codes and the number of times of deleting codes in the value₁ in the preBehaviorSequence are consistent with those in the valueₘ in the finBehaviorSequence are checked, and if not, Step2.9 is executed;

Step2.9, n++, n=2, Step2.6 is executed;

Step2.6, whether the finBehaviorSequence is traversed completely is judged, n=2, key₂=‘import’, value₂=‘chofCACP1’, Step2.7 is executed;

Step2.7, whether the source of the deleted codes and the number of times of deleting codes in the value₁ in the preBehaviorSequence are consistent with those in the valueₘ in the finBehaviorSequence are checked, code sources are the automatic code generation tool and the numbers of times are 1 respectively, Step2.8 is executed;

Step2.8, the keyₘ and the valueₘ are deleted, key₂=‘import’ is deleted, value₂=‘chofCACP1’, n=0, finBehaviorSequence={def=‘typ1’, ‘fac(n):’=‘typ2’}, I++,I=4, m−−, m=2, Step2.2 is executed;

Step2.2, whether the preBehaviorSequence is traversed completely is judged, 1=4, key₄=‘If’, value₄=‘chofCACP2’, Step2.3 is executed;

Step2.3, whether the value₄ in the preBehaviorSequence contains ‘Cho’ is judged, value4=‘chofCACP2’, and Step2.4 is executed;

Step 2.4, m=2, I=4, keyₘ=key₁, key₂=‘If’, valueₘ=value₁, value₂=‘chofCACP2’, the key₂ and the value₂ are saved into the finBehaviorSequence, finBehaviorSequence={‘def=‘typ1’,‘fac(n):’=‘typ2’,‘if’=‘chofCACP2’}, m++, m=3, I++, I=5, Step2.2 is executed;

Step2.2, whether the preBehaviorSequence is traversed completely is judged, I=5, key₅=‘n==1:’, value₅=‘typ3’, and Step2.3 is executed;

Step2.3, whether the value₅ in the preBehaviorSequence contains ‘Cho’ is judged, value₅=‘typ3’, and Step2.5 is executed;

Step2.5, whether the value₅ in the preBehaviorSequence contains ‘typ’ is judged, value₅=‘typ3’, Step2.4 is executed;

Step2.4, m=3, I=5, keyₘ=key₁, key₃=‘n==1:’, valueₘ=value₁, value₃=‘typ3’, the key₃ and the value₃ are saved into the finBehaviorSequence, finBehaviorSequence={‘def’=‘typ1’,‘fac(n):’=‘typ2’, ‘if’=‘chofCACP2’,‘n==1:’=‘typ3’}, m++, m=4, I++, I=6, Step2.2 is executed;

Step2.2, whether the preBehaviorSequence is traversed completely is judged, key₆=‘reversed’, valuee=‘chofIDE1’, and Step2.3 is executed:

Step2.3, whether the value₆ in the preBehaviorSequence contains ‘Cho’ is judged, value₆=‘chofIDE1’, and Step2.4 is executed;

Step2.4, m=4, I=6, keyₘ=key₁, key₄=‘reversed’, valueₘ=value₁, value₄=‘chofIDE1’, the key₄ and the value₄ are saved into the finBehaviorSequence, finBehaviorSequence={‘def’=‘typ1’,‘fac(n):’=‘type2’, ‘if’=‘chofCACP2’,‘n==1:’=‘typ3’, ‘reversed’=‘chofIDE1’}, m++, m=5, I++, I=7, Step2.2 is executed;

Step2.2, whether the preBehaviorSequence is traversed completely is judged, 1=7, key₇=‘reversed’, value₇=‘delfIDE1’, and Step2.3 is executed;

Step2.3, whether the value₇ in the preBehaviorSequence contains ‘Cho’ is judged, value₇=‘deflDE1’, and Step2.5 is executed:

Step2.5, whether the value₇ in the preBehaviorSequence contains ‘typ’ is judged, value₇=‘deflDE1’, Step2.6 is executed;

Step2.6, whether the finBehaviorSequence is traversed completely is judged, n=0, key₀=‘def’, value₀=‘typ1’, Step2.7 is executed;

Step2.7, whether the source of deleted codes in the value₁ and the number of times of deleting codes in the value₁ in the preBehaviorSequence are consistent with those in the valueₘ in the finBehaviorSequence are checked, and if not, Step2.9 is executed;

Step2.9, n++, n=1, Step2.6 is executed;

Step2.6, whether the finBehaviorSequence is traversed completely is judged, n=1, key₁=‘fac(n):’, value₁=‘type2’, Step2.7 is executed;

Step2.7, whether the source of the deleted codes in the value₁ and the number of times of deleting codes in the value₁ in the preBehaviorSequence are consistent with those in the valueₘ in the finBehaviorSequence are checked, and if not, Step2.9 is executed;

Step2.9, n++, n=2, Step2.6 is executed;

Step2.6, whether the finBehaviorSequence is traversed completely is judged, n=2, key₂=‘If’, value2=‘chofCACP2’, Step2.7 is executed;

Step2.7, whether the source of the deleted codes in the value₁ and the number of times of deleting codes in the value₁ in the preBehaviorSequence are consistent with those in the valueₘ in the finBehaviorSequence are checked, and if not, Step2.9 is executed;

Step2.9, n++, n=3, Step2.6 is executed;

Step2.6, whether the finBehaviorSequence is traversed completely is judged, n=3, key₃=‘n==1:’, value₃=‘typ3’, Step2.7 is executed;

Step2.7, whether the source of the deleted codes in the value₁ and the number of times of deleting codes in the value₁ in the preBehaviorSequence are consistent with those in the valueₘ in the finBehaviorSequence are checked, and if not, Step2.9 is executed;

Step2.9, n++, n=4, Step2.6 is executed;

Step2.6, whether the finBehaviorSequence is traversed completely is judged, n=4, key₄=‘reversed’, value4=‘chofIDE1’, Step2.7 is executed;

Step2.7, whether the source of the deleted codes in the value₁ and the number of times of deleting codes in the value₁ in the preBehaviorSequence are consistent with those in the valueₘ in the finBehaviorSequence are checked, the source of the code is the programming platform and the number of times is 1 respectively, and Step2.8 is executed;

Step2.8, the keyₘ and the valueₘ is deleted, the key₄=‘reversed’ is deleted, value₄=‘chofIDE1’, finBehaviorSequence={‘def’=‘typ1’,‘fac(n):’=‘typ2’, ‘if’=‘chofCACP2’,‘n==1:’=‘typ3’}, n=0, I++, I=8, m−−, m=4, Step2.2 is executed;

Step2.2, whether the preBehaviorSequence is traversed completely is judged, I=8, key₈=‘return’, value₈=‘chofIDE2’, Step2.3 is executed;

Step2.3, whether the value₈ in the preBehaviorSequence contains ‘Cho’ is judged, value₈=‘chofIDE2’, and Step2.4 is executed;

Step2.4, m=4, I=8, keyₘ=key₁, key₄=‘return’, valueₘ=value₁, value₄=‘chofIDE2’, the key₄ and the value₄ are saved into the finBehaviorSequence, finBehaviorSequence={‘def’=‘typ1’,‘fac(n):’=‘typ2’, ‘if’=‘chofCACP2’,‘n==1:’=‘typ3’, ‘return’=‘chofIDE2’}, m++, m=5, I++, I=9, Step2.2 is executed;

Step2.2, whether the preBehaviorSequence is traversed completely is judged, 1=9, key₉=‘2’, value₉=‘typ4’, and Step2.3 is executed;

Step2.3, whether the value₁ in the preBehaviorSequence contains ‘Cho’ is judged, value₉=‘type4’, and Step2.5 is executed;

Step2.5, whether the value₁ in the preBehaviorSequence contains “typ” is judged, value₉=‘typ4’, Step2.4 is executed;

Step2.4, m=5, I=9, keyₘ=key₁, key₅=‘2’, valueₘ=value1, value₃=‘typ4’, the key₅ and the value₅ are saved into the finBehaviorSequence, finBehaviorSequence={‘def’=‘typ1’,‘fac(n):’=‘typ2’, ‘if’=‘chofCACP2’,‘n==1:’=‘typ3’, ‘return’=‘chofIDE2’,‘2’=‘typ4’}, m++, m=6, I++, I=10, Step2.2 is executed;

Step2.2, whether the preBehaviorSequence is traversed completely is judged, I=10, key₁₀=‘2’, value₁₀=‘delfPRO4’, and Step2.3 is executed;

Step2.3, whether the value₁ in the preBehaviorSequence contains ‘Cho’ is judged, value₁₀=‘delfPRO4’, and Step2.5 is executed;

Step2.5, whether the value₁ in the preBehaviorSequence contains ‘typ’ is judged, value₁₀=‘delfPRO4’, Step2.6 is executed;

Step2.6, whether the finBehaviorSequence is traversed completely is judged, n=0, key₀=‘def’, value₀=‘typ1’, Step2.7 is executed;

Step2.7, whether the source of the deleted codes in the value₁ and the number of times of deleting codes in the value, in the preBehaviorSequence are consistent with those in the valueₘ in the finBehaviorSequence are checked, and if not, Step2.9 is executed;

Step2.9, n++, n=1, Step2.6 is executed;

Step2.6, whether the finBehaviorSequence is traversed completely is judged, n=1, key₁=‘fac(n):’, value₁=‘type2’, Step2.7 is executed;

Step2.7, whether the source of the deleted codes in the value₁ and the number of times of deleting codes in the value, in the preBehaviorSequence are consistent with those in the valueₘ in the finBehaviorSequence are checked, and if not, Step2.9 is executed;

Step2.9, n++, n=2, Step2.6 is executed;

Step2.6, whether the finBehaviorSequence is traversed completely is judged, n=2, key₂=‘If’, value₂=‘chofCACP2’, Step2.7 is executed;

Step2.7, whether the source of the deleted codes in the value₁ and the number of times of deleting codes in the value₁ in the preBehaviorSequence are consistent with those in the valueₘ in the finBehaviorSequence are checked, and if not, Step2.9 is executed;

Step2.9, n++, n=3, Step2.6 is executed;

Step2.6, whether the finBehaviorSequence is traversed completely is judged, n=3, key₃=‘n==1:’, value₃=‘typ3’, Step2.7 is executed;

Step2.7, whether the source of the deleted codes in the value1 and the number of times of deleting codes in the value1 in the preBehaviorSequence are consistent with those in the valueₘ in the finBehaviorSequence are checked, and if not, Step2.9 is executed;

Step2.9, n++, n=4, Step2.6 is executed;

Step2.6, whether the finBehaviorSequence is traversed completely is judged, n=4, key₄=‘return’, value₄=‘chofIDE2’, Step2.7 is executed;

Step2.7, whether the source of the deleted codes in the value1 and the number of times of deleting codes in the value1 in the preBehaviorSequence are consistent with those in the valueₘ in the finBehaviorSequence are checked, and if not, Step2.9 is executed;

Step2.9, n++, n=5, Step2.6 is executed;

Step2.6, whether the finBehaviorSequence is traversed completely is judged, key₅=‘2’, value₅=‘typ4’, Step 2.7 is executed;

Step2.7, whether the source of the deleted codes in the value1 and the number of times of deleting codes in the value1 in the preBehaviorSequence are consistent with those in the valueₘ in the finBehaviorSequence are checked, the source of the codes is the programmer and the number of times is 4 respectively, and Step2.8 is executed;

Step2.8, the keyₘ and the valueₘ are deleted, the key₅=‘2’ is deleted, value₅=‘typ4’, finBehaviorSequence={{‘def=‘typ1’,‘fac(n):’=‘typ2’, ‘if’=‘chofCACP2’,‘n==1:’=‘typ3’, ‘return’=‘chofIDE2’}, n=0, I++, I=11, m−−, m=5, Step2.2 is executed;

Step2.2, whether the preBehaviorSequence is traversed completely is judged, I=11, key₁₁=‘1’, value₁₁=‘typ5’, and Step2.3 is executed;

Step2.3, whether the value₁₁ in the preBehaviorSequence contains ‘Cho’ is judged, value₁₁=‘type5’, and Step2.5 is executed;

Step2.5, whether the value₁₁ in the preBehaviorSequence contains ‘typ’ is judged, value₁₁=‘typ5’, Step2.4 is executed;

Step 2.4, m=5, I=11, keyₘ=key1, key₅=‘2’, valueₘ=value₁, value₅=‘typ4’, the key₅ and the value₅ are saved into the finBehaviorSequence, finBehaviorSequence={def=‘typ1’,‘fac(n):’=‘typ2’, ‘if’=‘chofCACP2’,‘n==1:’=‘typ3’, ‘return’=‘chofIDE2’,‘1’=typ5’}, m++, m=6, I++, I=12, Step2.2 is executed.

Step2.2, whether the preBehaviorSequence is traversed completely is judged, and Step3 is executed. At this time, the processed behavior sequence finBehaviorSequence is shown in Table 4.

TABLE 4

| Serial No. | Data |
|---|---|
| 0 | key₀=‘def’, value₀=‘typ1’ |
| 1 | key₁=‘fac(n):’, value₁=‘typ2’ |
| 2 | key₄=‘if’, value₄=‘chofCACP2’ |
| 3 | key₅=‘n==1:’, value₅=‘typ3’ |
| 4 | key₈=‘return’, value₈=‘chofIDE2’ |
| 5 | key₁₁=‘1’, value₁₁=‘typ5’ |

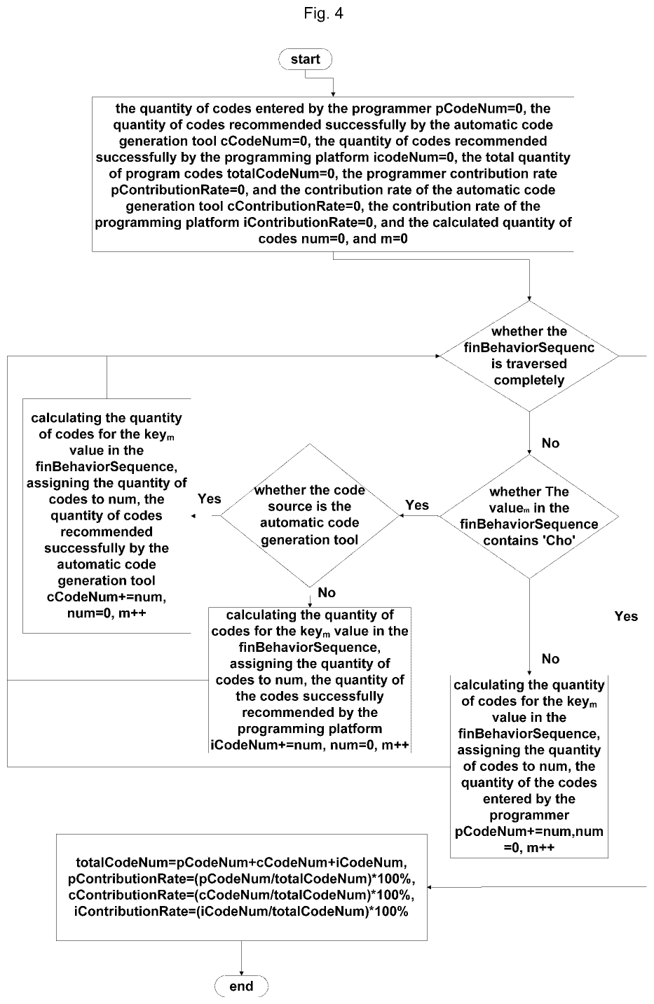

FIG. 4 is a process diagram of analyzing programming contribution rates according to an optional embodiment of the present disclosure. As shown in FIG. 4, analyzing programming contribution rates includes the following implementation steps:

Step3.1, as the quantity of the codes entered by the programmer pCodeNum is 0, the quantity of the codes recommended successfully by the automatic code generation tool cCodeNum is 0, the quantity of the codes recommended successfully by the programming platform icodeNum is 0, the total quantity of the program codes totalCodeNum is 0, the programmer contribution rate pContributionRate is 0, and the contribution rate of the automatic code generation tool cContributionRate is 0, the contribution rate of the programming platform iContributionRate is 0, and the quantity of the codes num which is calculated is 0, and m is 0, Step3.2 is executed, and calculation rules of the quantity of Java/Python language codes are shown in Table 5;

TABLE 5

| Code element | Quantity | Code Example |
|---|---|---|
| Separator | 0 | Java: ;, { }, ( ), . |
| | | Python: :, ,, ( ), . |
| Arithmetic operator | 1 | +, −, *, /, %, ++, −− |
| Assignment operator | 1 | =, +=, −=, *=, /=, %= |
| Comparison operator | 1 | ==, !=, >, <, >=, <= |
| Logical operator | 1 | &, &&, \|, \|\|, !, \hat{ } |
| Shift operator | 1 | <<, >>, >>> |
| Annotation | 0 | Java: /*S*/, //S |
| | | Python: #S, “‘S’”, “““S””” |
| Function name | 1 | add( ) |
| Formal parameter, Actual | 1 | formal parameter ‘s’ in add(S), and actual parameter |
| parameter | | ‘1’ in add(1) |

Step3.2, whether the finBehaviorSequence is traversed completely is judged, m=0, key₀=‘def’, value₀=‘typ1’, Step3.4 is executed;

Step3.4, whether value in the finBehaviorSequence contains ‘Cho’ is judged, value₀=‘type1’, and Step3.8 is executed;

Step3.8, the code quantity of keyₘ value in the finBehaviorSequence is calculated, key₀=‘def’, the code quantity is assigned to num, num=1, the code quantity pCodeNum+=num is entered by the programmer, pCodeNum=1, num=0, m++, and Step3.2 is executed;

Step 3.2, whether the finBehaviorSequence is traversed completely is judged, m=1, key₁=‘fac(n):’, value₁=‘type2’, Step3.4 is executed;

Step3.4, whether the value in the finBehaviorSequence contains ‘Cho’ is judged, value₁=‘type2’, and Step3.8 is executed;

Step3.8, the code quantity of keyₘ value in the finBehaviorSequence is calculated, key₁=‘fac(n):’, the code quantity is assigned to the num, num=2, the code quantity pCodeNum+=num is entered by the programmer, pCodeNum=3, num=0, m++, and Step3.2 is executed;

Step3.2, whether the finBehaviorSequence is traversed completely is judged, m=2, key₂=‘If’, value₂=‘chofCACP2’, Step3.4 is executed;

Step3.4, whether the value in the finBehaviorSequence contains ‘Cho’ is judged, value₂=‘chofCACP2’, and Step3.5 is executed;

Step 3.5, whether the code source is the automatic code generation tool is judged, and if the code source is the automatic code generation tool, Step3.6 is executed;

Step3.6, the quantity of codes in the keyₘ value in the finBehaviorSequence is calculated, the quantity of the codes is assigned to the num, num=1, the quantity of the codes recommended by the automatic code generation tool cCodeNum+=num, cCodeNum=1, num=0, m++, and Step3.2 is executed;

Step3.2, whether the finBehaviorSequence is traversed completely is judged, m=3, key₃=‘n==1:’, value₃=‘typ3’, Step3.4 is executed;

Step3.4, whether the value in the finBehaviorSequence contains ‘Cho’ is judged, value₃=‘typ3’, and Step3.8 is executed;

Step3.8, the quantity of the codes in the keyₘ value in the finBehaviorSequence is calculated, key₃=‘n==1:’, the quantity of the codes is assigned to the num, num=3, the quantity of the codes entered by the programmer pCodeNum+=num, pCodeNum=6, num=0, m++, and Step3.2 is executed;

Step3.2, whether the finBehaviorSequence is traversed completely is judged, m=4, key₄=‘return’, value₄=‘chofIDE2’, Step3.4 is executed;

Step3.4, whether the value in the finBehaviorSequence contains ‘Cho’ is judged, value₄=‘chofIDE2’, and Step3.5 is executed:

Step3.5, whether the code source is the automatic code generation tool is judged, and if the code source is the programming platform, Step3.7 is executed;

Step3.7, the quantity of the codes in the keyₘ value in the finBehaviorSequence is calculated, the quantity of the codes is assigned to the num, num=1, the quantity of the codes successfully recommended by the programming platform iCodeNum+=num, iCodeNum=1, num=0, m++, and Step3.2 is executed;

Step3.2, whether the finBehaviorSequence is traversed completely is judged, m=5, key₅=‘1’, value₅=‘typ5’, Step3.4 is executed;

Step3.4, whether the value in the finBehaviorSequence contains ‘Cho’ is judged, value₃=‘type5’, and Step3.8 is executed;

Step3.8, the quantity of the codes in the keyₘ value in the finBehaviorSequence is calculated, key₅=‘1’, the quantity of the codes is assigned to the num, num=1, the quantity of the codes entered by the programmer pCodeNum+=num, pCodeNum=7, num=0, m++, and Step3.2 is executed;

Step3.2, whether the finBehaviorSequence is traversed completely is judged, and Step3.3 is executed;

Step3.3, totalCodeNum=pCodeNum+cCodeNum+iCodeNum,

totalCodeNum=9,

pContrbutionRate=(pCodeNum/totalCodeNum)*100%=(7/9)*100%=77.78%,

cContributionRate=(cCodeNumltotalCodeNum)*100%=(1/9)*100%=11.11%,

iContributionRate=(iCodeNum/totalCodeNum)*100%=(1/9)*100%=11.11%, end.

Further, by the above embodiments, the present disclosure has the following beneficial effects that a behavior is defined based on operations of the programmer in the programming process, contributing to distinguishing behaviors and functions of the different roles in the programming process; capturing the programming process data and analyzing related behaviors help calculate contributions of the programmer, the automatic code generation tool and the programming platform on the program.

### Embodiment 2

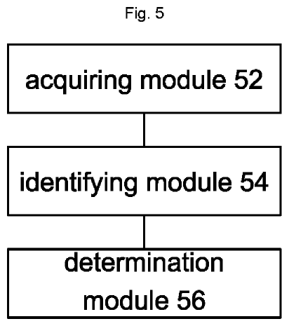

According to another aspect of the embodiment of the present disclosure, there further provides an apparatus for processing programming data. FIG. 5 is a schematic diagram of the apparatus for processing the programming data according to an embodiment of the present disclosure. As shown in FIG. 5, the apparatus for processing the programming data, includes an acquiring module 52, an identifying module 54 and a determination module 56. The apparatus for processing the programming data will be explained in detail below.

The acquiring module 52 is configured for acquiring the programming data of a target object; the identifying module 54 is connected to the acquiring module 52 and configured for identifying a programming behavior of the target object according to the programming data; the determination module 56 is connected to the identifying module 54 and configured for determining programming contribution rates of the target object, an automatic code generation tool and a programming platform according to the programming behavior.

It should be noted that, all of the modules above can be implemented by software or hardware, for example, if it is the latter, they can be located in a same processor; and/or all of the modules can be located in different processors at any arbitrary combination.

In the above embodiment, through capturing the programming data in a programming process and analyzing related behaviors in the programming process, the apparatus for processing the programming data has the beneficial effect that behaviors and functions of different roles in the programming process are distinguished and contributions of the different roles on programs are determined, thereby realizing the technical effect of rapidly and accurately grasping the contributions of the programmer, the automatic code generation tool and the programming platform on the programs, and thereby further resolving the technical problem in the related technologies that the behaviors and the functions of the programmer, the automatic code generation tool and the programming platform cannot be clearly distinguished in the programming process so as not to reflect their respective contribution on programming efficiency and quality.

It should be noted that, the acquiring module 52, the identifying module 54 and the determination module 56 mentioned above correspond to steps S102 to S106 in Embodiment 1. The above modules and corresponding steps are achieved in same examples and application scenes, but not limited to the disclosure of Embodiment 1.

Optionally, the acquiring module 52 further includes: a processing unit, configured for monitoring key operations of the target object in a programming process with the automatic code generation tool to acquire the programming data of the target object, and the programming data include at least one of: codes entered by the target object, selected codes recommended by the automatic code generation tool, selected codes recommended by the programming platform, deleted codes entered by the target object, deleted codes recommended by the automatic code generation tool, and deleted codes recommended by the programming platform.

Optionally, the identifying module 54 includes: a first determination unit configured for determining the programming behavior of the target object is a behavior of entering codes by the target object according to codes that are entered by the target object and are not deleted in the programming data; a second determination unit configured for determining the programming behavior of the target object is a behavior of successfully recommending codes by the automatic code generation tool according to codes that are recommended by the automatic code generation tool, selected by the target object, and are not deleted in the programming data; and a third determination unit configured for determining the programming behavior of the target object is a behavior of successfully recommending codes by the programming platform according to codes that are recommended by the programming platform, selected by the target object, and are not deleted in the programming data.

Optionally, the determination module 56 includes: a fourth determination unit configured for determining a quantity of codes entered by the target object, a quantity of codes successfully recommended by the automatic code generation tool, and a quantity of codes successfully recommended by the programming platform according to the programming behavior; a first acquiring unit configured for acquiring a total quantity of codes according to the quantity of the codes entered by the target object, the quantity of the codes successfully recommended by the automatic code generation tool, and the quantity of the codes successfully recommended by the programming platform; and a second acquiring unit configured for acquiring the programming contribution rates of the target object, the automatic code generation tool and the programming platform according to the quantity of the codes entered by the target object, the quantity of the codes successfully recommended by the automatic code generation tool, the quantity of the codes successfully recommended by the programming platform, and the total quantity of the codes.

Optionally, the programming behavior includes a behavior of entering codes by the target object, a behavior of successfully recommending codes by the automatic code generation tool and a behavior of successfully recommending codes by the programming platform; and the fourth determination unit includes: a first determination subunit, configured for determining the quantity of the codes entered by the target object according to the behavior of entering codes by the target object; a second determination subunit, configured for determining the quantity of the codes successfully recommended by the automatic code generation tool according to the behavior of successfully recommending codes by the automatic code generation tool; and a third determination subunit, configured for determining the quantity of the codes successfully recommended by the programming platform according to the behavior of successfully recommending codes by the programming platform.

Optionally, the second acquiring unit includes: a first acquiring subunit, configured for acquiring a programming contribution rate of the target object according to the quantity of the codes entered by the target object and the total quantity of the codes; a second acquiring subunit, configured for acquiring a programming contribution rate of the automatic code generation tool according to the quantity of the codes successfully recommended by the automatic code generation tool and the total quantity of the codes; and a third acquiring subunit, configured for acquiring a programming contribution rate of the programming platform according to the quantity of the codes successfully recommended by the programming platform and the total quantity of the codes.

### Embodiment 3

According to another aspect of the embodiment of the present disclosure, there further provides a computer readable storage medium, and the computer readable storage medium includes a program stored thereon, and the program controls a device where the computer readable storage medium is located to execute the method for processing the programming data when the program runs.

Optionally, in this embodiment, the computer readable storage medium can be in any computer terminal of a computer terminal group of a computer network, and in any mobile terminal of a mobile terminal group, or the computer readable storage medium can be in any computer terminal of the computer terminal group of the computer network or the computer readable storage medium can be in any mobile terminal of the mobile terminal group, and the computer readable storage medium includes the program stored thereon.

Optionally, the program controls a device on which the computer readable storage medium resides to implement the following functions when being run: acquiring the programming data of a target object; identifying a programming behavior of the target object according to the programming data; and determining programming contribution rates of the target object, an automatic code generation tool and programming platform according to the programming behavior.

### Embodiment 4

According to another aspect of the present disclosure, there further provides a processor, configured for running a program, and the program executes the method for processing the programming data when being run.

The embodiment of the present disclosure provides a device, which includes a processor, a memory and a program stored on the memory and executed on the processor, and the processor executing the program includes the following steps: acquiring the programming data of a target object; identifying a programming behavior of the target object according to the programming data; and determining programming contribution rates of the target object, an automatic code generation tool and a programming platform according to the programming behavior.

The present disclosure also provides a computer program product. Any program with the following initiation method steps, when executed on a data processing device, are proper acquiring the programming data of a target object; identifying a programming behavior of the target object according to the programming data; and determining programming contribution rates of the target object, an automatic code generation tool and a programming platform according to the programming behavior.

The serial numbers of the above embodiments of the present disclosure merely serve the purpose of description, rather than indicating superiorities of the embodiments.

In the above embodiments of the present disclosure, the description of each embodiment has its own emphasis. For the parts not clarified in some embodiment, please refer to the relevant description of other embodiments.

In several embodiments provided in the present application, it should be understood that, the disclosed technical content may be realized in other ways. And, the device embodiments described above are only schematic, for example, division of the unit may be a logical function division, but instead refers to other division modes in actual implementation. For example, multiple units or components may be combined or integrated into another system, or some features may be ignored or not executed. In addition, the mutual coupling or direct coupling or communication connection shown or discussed may refer to indirect coupling or communication connection through some interfaces, units or modules, and may be electrical or in other forms.

The unit described as a separate component may or may not be physically separated, and the component displayed as a unit may or may not be a physical unit, i.e., it may be located in one place or distributed on a plurality of units. A part or all of the units can be selected to achieve the purpose of the solution of the embodiment according to actual needs.

In addition, each functional unit in each embodiment of the present disclosure can be integrated in one processing unit, each unit can exist separately, or two or more units may be integrated in one unit. The above integrated unit may be realized in the form of hardware or software functional units.

If the integrated unit is realized in the form of a software functional unit and sold or used as an independent product, it can be stored in a computer-readable storage medium. According to this understanding, the technical solution of the present disclosure in essence, or the part that contributes to the prior art, or all or a part of the technical solution can be embodied in the form of a software product, which may be stored in a storage medium and includes several instructions for making a computer device (e.g., a personal computer, a server, a network device, etc.) execute all or part of the steps of the method described in each embodiment of the present disclosure. The aforementioned storage medium includes: a USB flash disk, a read only memory (ROM), a random access memory (RAM), a mobile hard disk, a magnetic disk or optical disk and other media that can store program codes.

The above is only the preferred embodiment of the present disclosure. It should be pointed out that, for an ordinary skilled person in the art, several improvements and refinements can be made without departing from the principles of the present disclosure, and these improvements and refinements should also be regarded as falling into the protection scope of the present disclosure.

What is claimed is:

1. A method for processing programming data, comprising:
acquiring the programming data of a target object;
identifying a programming behavior of the target object according to the programming data; and
determining programming contribution rates of the target object, an automatic code generation tool and a programming platform according to the programming behavior.

2. The method according to claim 1, wherein acquiring the programming data of the target object, comprises:
monitoring key operations of the target object in a programming process with the automatic code generation tool to acquire the programming data of the target object, wherein the programming data comprise at least one of: codes entered by the target object, selected codes recommended by the automatic code generation tool, selected codes recommended by the programming platform, deleted codes entered by the target object, deleted codes recommended by the automatic code generation tool, and deleted codes recommended by the programming platform.

3. The method according to claim 1, wherein identifying the programming behavior of the target object according to the programming data, comprises:
determining the programming behavior of the target object is a behavior of entering codes by the target object according to codes that are entered by the target object and are not deleted in the programming data;
determining the programming behavior of the target object is a behavior of successfully recommending codes by the automatic code generation tool according to codes that are recommended by the automatic code generation tool, selected by the target object, and are not deleted in the programming data; and
determining the programming behavior of the target object is a behavior of successfully recommending codes by the programming platform according to codes that are recommended by the programming platform, selected by the target object, and are not deleted in the programming data.

4. The method according to claim 1, wherein determining the programming contribution rates of the target object, the automatic code generation tool and the programming platform according to the programming behavior, comprises:
determining a quantity of codes entered by the target object, a quantity of codes successfully recommended by the automatic code generation tool, and a quantity of codes successfully recommended by the programming platform according to the programming behavior;
acquiring a total quantity of codes according to the quantity of the codes entered by the target object, the quantity of the codes successfully recommended by the automatic code generation tool, and the quantity of the codes successfully recommended by the programming platform; and
acquiring the programming contribution rates of the target object, the automatic code generation tool and the programming platform according to the quantity of the codes entered by the target object, the quantity of the codes successfully recommended by the automatic code generation tool, the quantity of the codes successfully recommended by the programming platform, and the total quantity of the codes.

5. The method according to claim 4, wherein the programming behavior comprises a behavior of entering codes by the target object, a behavior of successfully recommending codes by the automatic code generation tool and a behavior of successfully recommending codes by the programming platform, and determining the quantity of the codes entered by the target object, the quantity of the codes successfully recommended by the automatic code generation tool, and the quantity of the codes successfully recommended by the programming platform according to the programming behavior, comprises:
determining the quantity of the codes entered by the target object according to the behavior of entering codes by the target object;
determining the quantity of the codes successfully recommended by the automatic code generation tool according to the behavior of successfully recommending codes by the automatic code generation tool; and
determining the quantity of the codes successfully recommended by the programming platform according to the behavior of successfully recommending codes by the programming platform.

6. The method according to claim 4, wherein acquiring the programming contribution rates of the target object, the automatic code generation tool and the programming platform according to the quantity of the codes entered by the target object, the quantity of the codes successfully recommended by the automatic code generation tool, the quantity of the codes successfully recommended by the programming platform, and the total quantity of the codes, comprises:
acquiring a programming contribution rate of the target object according to the quantity of the codes entered by the target object and the total quantity of the codes;
acquiring a programming contribution rate of the automatic code generation tool according to the quantity of the codes successfully recommended by the automatic code generation tool and the total quantity of the codes; and
acquiring a programming contribution rate of the programming platform according to the quantity of the codes successfully recommended by the programming platform and the total quantity of the codes.

7. An apparatus for processing programming data, comprising:
an acquiring module, configured for acquiring the programming data of a target object;
an identifying module, configured for identifying a programming behavior of the target object according to the programming data;
a determination module, configured for determining programming contribution rates of the target object, an automatic code generation tool and a programming platform according to the programming behavior.

8. The apparatus according to claim 7, wherein the acquiring module comprises:
a processing unit, configured for monitoring key operations of the target object in a programming process with the automatic code generation tool to acquire the programming data of the target object, wherein the programming data comprise at least one of: codes entered by the target object, selected codes recommended by the automatic code generation tool, selected codes recommended by the programming platform, deleted codes entered by the target object, deleted codes recommended by the automatic code generation tool, and deleted codes recommended by the programming platform.

9. A processor, wherein the processor is configured for running a program, wherein the program executes a method for processing programming data when the program runs,
the method for processing the programming data, comprising:
acquiring the programming data of a target object;
identifying a programming behavior of the target object according to the programming data; and
determining programming contribution rates of the target object, an automatic code generation tool and a programming platform according to the programming behavior.

10. The processor according to claim 9, wherein acquiring the programming data of the target object, comprises:
monitoring key operations of the target object in a programming process with the automatic code generation tool to acquire the programming data of the target object, wherein the programming data comprise at least one of: codes entered by the target object, selected codes recommended by the automatic code generation tool, selected codes recommended by the programming platform, deleted codes entered by the target object, deleted codes recommended by the automatic code generation tool, and deleted codes recommended by the programming platform.

11. The processor according to claim 9, wherein identifying the programming behavior of the target object according to the programming data, comprises:
determining the programming behavior of the target object is a behavior of entering codes by the target object according to codes that are entered by the target object and are not deleted in the programming data;
determining the programming behavior of the target object is a behavior of successfully recommending codes by the automatic code generation tool according to codes that are recommended by the automatic code generation tool, selected by the target object, and are not deleted in the programming data; and
determining the programming behavior of the target object is a behavior of successfully recommending codes by the programming platform according to codes that are recommended by the programming platform, selected by the target object, and are not deleted in the programming data.

12. The processor according to claim 9, wherein determining the programming contribution rates of the target object, the automatic code generation tool and the programming platform according to the programming behavior, comprises:
determining a quantity of codes entered by the target object, a quantity of codes successfully recommended by the automatic code generation tool, and a quantity of codes successfully recommended by the programming platform according to the programming behavior;
acquiring a total quantity of codes according to the quantity of the codes entered by the target object, the quantity of the codes successfully recommended by the automatic code generation tool, and the quantity of the codes successfully recommended by the programming platform; and
acquiring the programming contribution rates of the target object, the automatic code generation tool and the programming platform according to the quantity of the codes entered by the target object, the quantity of the codes successfully recommended by the automatic code generation tool, the quantity of the codes successfully recommended by the programming platform, and the total quantity of the codes.

13. The processor according to claim 12, wherein the programming behavior comprises a behavior of entering codes by the target object, a behavior of successfully recommending codes by the automatic code generation tool and a behavior of successfully recommending codes by the programming platform, and determining the quantity of the codes entered by the target object, the quantity of the codes successfully recommended by the automatic code generation tool, and the quantity of the codes successfully recommended by the programming platform according to the programming behavior, comprises:
determining the quantity of the codes entered by the target object according to the behavior of entering codes by the target object;
determining the quantity of the codes successfully recommended by the automatic code generation tool according to the behavior of successfully recommending codes by the automatic code generation tool; and
determining the quantity of the codes successfully recommended by the programming platform according to the behavior of successfully recommending codes by the programming platform.

14. The processor according to claim 12, wherein acquiring the programming contribution rates of the target object, the automatic code generation tool and the programming platform according to the quantity of the codes entered by the target object, the quantity of the codes successfully recommended by the automatic code generation tool, the quantity of the codes successfully recommended by the programming platform, and the total quantity of the codes, comprises:
acquiring a programming contribution rate of the target object according to the quantity of the codes entered by the target object and the total quantity of the codes;
acquiring a programming contribution rate of the automatic code generation tool according to the quantity of the codes successfully recommended by the automatic code generation tool and the total quantity of the codes; and
acquiring a programming contribution rate of the programming platform according to the quantity of the codes successfully recommended by the programming platform and the total quantity of the codes.
